(19) United States
(12) Patent Application Publication
(10) Pub. No.: US 2016/0294441 A1
(43) Pub. Date: Oct. 6, 2016

(54) Copper-Assisted Fifth Generation (5G) Wireless Access to Indoor

(71) Applicant: Futurewei Technologies, Inc., Plano, TX (US)

(72) Inventors: Amir H. Fazlollahi, San Jose, CA (US); Jiangnan Jason Chen, Hawthorn Woods, IL (US)

(21) Appl. No.: 15/080,064

(22) Filed: Mar. 24, 2016

Related U.S. Application Data
(60) Provisional application No. 62/140,224, filed on Mar. 30, 2015.

(51) Int. Cl. H04B 3/36; H04L 5/14; H04B 7/04

(52) U.S. Cl. CPC H04B 3/36; H04B 7/0413; H04L 5/14

(57) ABSTRACT

A network element including a relay station disposed outside a structure, wherein the relay station is configured to convert a radio frequency signal received from a base station into baseband signals and to frame the baseband signals into data packets, and a transceiver disposed outside the structure and operably coupled to the relay station, wherein the transceiver is configured to receive the data packets from the relay station and to transmit the data packets over copper wire pairs to a second transceiver disposed within the structure and coupled to an indoor radio station so that the indoor radio station is able to convert the data packets back into the radio frequency signal and transmit the radio frequency signal to a user equipment within the structure.

### CROSS-REFERENCE TO RELATED APPLICATIONS

The present application claims priority to U.S. Provisional Patent Application 62/140,224 filed Mar. 30, 2015, by Amir H. Fazlollahi and Jiangnan Jason Chen and entitled “Copper-Assisted Fifth Generation (5G) Wireless Access to Indoor,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Next generation wireless cellular networks (e.g., 5^{th} generation (5G) mobile networks, etc.) operating in a millimeter-Wave (mmWave) band (e.g., 6 Giga Hertz (GHz) to 300 GHz) target a peak rate of 10 Gigabits per second (Gb/s) for both outdoor and indoor applications. However, in this frequency band penetration through, for example, brick pillars, concrete walls, tinted glass, and the like hits a barrier of 30 decibels (dB) or more attenuation. Therefore, any user equipment (UE) such as a smart phone, tablet device, personal computer, etc., within a structure may not receive a sufficiently robust signal.

### SUMMARY

In an embodiment, the disclosure includes a network element including a relay station disposed outside a structure, wherein the relay station is configured to convert a radio frequency signal received from a base station into baseband signals and to frame the baseband signals into data packets, and a transceiver disposed outside the structure and operably coupled to the relay station, wherein the transceiver is configured to receive the data packets from the relay station and to transmit the data packets over copper wire pairs to a second transceiver disposed within the structure and coupled to an indoor radio station so that the indoor radio station is able to convert the data packets back into the radio frequency signal and transmit the radio frequency signal to a user equipment within the structure.

In an embodiment, the transceiver and the second transceiver use one or both of an overlapped spectrum full-duplexing technique and multiple-input-multiple-output (MIMO) technique for data transmission. In an embodiment, the transceiver is configured to transmit the data packets to the transceiver within the structure over copper wire pairs having N differential modes and 0 to N−1 phantom modes to form up to 2N−1 channels, where N is an integer number from 1 to 8. In an embodiment, the relay station comprises a millimeter-Wave (mmWave) relay station. In an embodiment, the relay station comprises a radio frequency (RF) repeater. In an embodiment, the structure is a residence or a business. In an embodiment, either In-phase-Quadrature (I-Q) samples or a representation of down converted radio frequency signal samples is framed into the data packets before being received by the transceiver. In an embodiment, the I-Q samples or the representation of the down converted radio frequency signal samples is compressed and framed into the data packets before being received by the transceiver. In an embodiment, information bits of the radio frequency signal are extracted and framed into the data packets before being received by the transceiver.

In an embodiment, the disclosure includes a network element including an indoor radio station within a structure configured to convert a radio frequency signal received from a user equipment into baseband signal framed data packets, and a transceiver within the structure and operably coupled to the indoor radio station, wherein the transceiver is configured to transmit the baseband signal framed data packets over copper wire pairs to a second transceiver outside the structure and coupled to a relay station so that the relay station is able to convert the baseband signal framed data packets back into the radio frequency signal and transmit the radio frequency signal to a small cell base station outside the structure.

In an embodiment, the transceiver and the second transceiver communicate over the copper wire pairs through one or both of overlapped-spectrum transmissions and multiple-input-multiple-output (MIMO) transmissions. In an embodiment, the transceiver is configured to transmit the baseband signal framed data packets to the second transceiver outside the structure over the copper wire pairs having N differential modes and 0 to N−1 phantom modes to form up to 2N−1 channels, where N is an integer number equal to 1 to 8. In an embodiment, either In-phase-Quadrature (I-Q) samples or a representation of down converted radio frequency signal samples is framed into the baseband signal framed data packets before received by the transceiver. In an embodiment, the I-Q samples or the representation of down converted radio frequency signal samples is compressed and framed into the baseband signal framed data packets before being received by the transceiver. In an embodiment, information bits of the radio frequency signal are extracted and framed into the data packets before being received by the transceiver.

In an embodiment, the disclosure includes a method of transmitting wireless signal over copper wires using one or both of overlapped spectrum full-duplexing transmission and multiple-input-multiple-output (MIMO) transmission including converting, by a relay station outside a structure, a radio frequency signal received from a base station outside the structure into baseband signals, framing, by the relay station, the baseband signals into data packets, transmitting, to a transceiver disposed outside the structure, the data packets, and transmitting, by the transceiver, the data packets over copper wire pairs to a second transceiver disposed within the structure and coupled to an indoor radio station so that the indoor radio station is able to convert the data packets back into the radio frequency signal and transmit the radio frequency signal to a user equipment within the structure.

In an embodiment, the method includes transmitting the data packets to the second transceiver within the structure over copper wire pairs having N differential modes and 0 to N−1 phantom modes to form up to 2N−1 channels, where N is an integer number equal to 1 to 8. In an embodiment, either In-phase-Quadrature (I-Q) samples or other representation of down converted radio frequency signal samples is framed into the data packets before being received by the transceiver. In an embodiment, the I-Q samples or the other representation of down converted radio frequency signal samples is compressed and framed into the data packets before being received by the transceiver. In an embodiment, information bits of the radio frequency signal are extracted and framed into the data packets before being received by the transceiver.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a network comprising fiber to the cabinet or curb (FTTC) connections, fiber to the distribution or drop point (FTTdp) connections, and fiber to the home (FTTH) connections.

FIG. 2 is a schematic diagram of an embodiment of a vectored digital subscriber line (DSL) system.

FIG. 3 is a schematic diagram of three channels created from two pairs of copper wire: (a) two differential modes and one alternative mode and (b) two differential modes and one phantom mode.

FIG. 4 is schematic diagram of an embodiment of a multiple-input-multiple-output (MIMO) system serving one residence or business subscriber.

FIG. 5 is a graph of an embodiment of simulation results of aggregate data rate versus loop length for two pairs of copper wire serving a residence or business.

FIG. 6 is a schematic diagram of an embodiment of a cellular copper-assisted wireless system for in house service.

FIG. 7 is a schematic diagram of an embodiment of a network element.

FIG. 8 is a flowchart of an embodiment of wireless access to indoor using overlapped spectrum full-duplexing multiple-input-multiple-output (MIMO) transmission over copper wires.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments of a multiple-input-multiple-output (MIMO) system that connects outdoor and indoor wireless radio frequency (RF)/relay stations using copper wire pairs so that fifth generation (5G) wireless cellular is accessible to users of user equipments (UEs) within residences or businesses through indoor wireless access. The MIMO system uses full-duplex overlapped spectrum for downstream and upstream transmission. The system is capable of transmitting and receiving 10 gigabits per second (Gbps) at up to 50 meters (m) or longer loops depending on the quality of wires used in different regions and different countries.

The mmWave frequency band is viewed as an inevitable band of choice for the upcoming fifth generation (5G) of the cellular network evolution. See, for example, Theodore S. Rappaport, et al, “Millimeter wave mobile communications for 5G cellular: It will work!,” IEEE Access vol. 1, Digital object identifier 10.1109/ACCESS.2013.2260813, May 2013, and Barry Lewis, “5G Mobile communications for 2020 and beyond,” Samsung Research UK, December 2014, which are incorporated herein in their entireties by reference. Given the expected extremely high number of devices and connections with very high data rates targeted by 5G, the existing popular lower cellular frequency bands do not have enough bandwidth to satisfy all these demands. Recent research in mmWave technology has shown that with multi-antenna arrays it is possible to deploy mmWave small cells as part of the bigger cellular heterogeneous networks. With the availability of a broad bandwidth in the mmWave bands, small cell base stations could easily provide not only wireless access capability, but also self-backhauling. Small cell base stations could be in a form of micro or Pico-cells, remote radio unit (RRU), or distributed mmWave RF antennas with a combination of distributed radio access network (D-RAN) or centralized radio access network (C-RAN) architecture.

Three major design objectives of fifth generation broadband wireless 5G cellular networks are implementation of massive capacity, massive connectivity, and low latency. The throughput target is 10 Gb/s peak data rate with at least 0.1 Gb/s at cell edges. See, for example, Barry Lewis, “5G Mobile communications for 2020 and beyond,” Samsung Research UK, December 2014, and Gerhard Fettweis and Siavash Alamouti, “5G: Personal mobile internet beyond what cellular did to telephony,” IEEE Comm. Magazine, February 2014, which is incorporated herein in their entireties by reference. Reconfigurable and re-routable multi-hop mmWave backhaul along with unified mmWave backhaul and access links will permit massive connectivity and easy deployment. The target latency is one to a few milliseconds to meet smart-home and smart-grid devices and connected sensors requirements. See, for example, Gerhard Fettweis and Siavash Alamouti, “5G: Personal mobile internet beyond what cellular did to telephony,” IEEE Comm. Magazine, February 2014, and Afif Osseiran, Ericsson, “Mobile and wireless communications system for 2020 and beyond (5G),” ITU-R 2020 Vision Workshop, Feb. 12, 2014, Vietnam.

Because of the 30 dB or more attenuation when the mmWave band encounters structural building components (e.g., brick pillars, concrete walls, tinted glass, etc.), an outdoor and indoor relay-station or other RF device will have to be placed as access nodes and connected by a mechanism. The connection of the outdoor and indoor wireless devices may be possible using fiber, coax cable, or copper wire pairs. While fiber and coax cable have their uses, they are not readily available in most regions and may be costly to install, especially fiber. Copper wires, however, are already installed in almost every house worldwide and have the capacity to play a role in the next generation 5G wireless access, which will be explained more fully below.

Digital subscriber line (DSL) technologies have been successfully employed over twisted-pair copper wires in hybrid Fiber-Copper access systems over the past two decades. A commercially available DSL technology called very high data rate subscriber line 2 (VDSL2) (which is described in International Telecommunications Union (ITU) standard G.993.2 and its vectored version which is described in ITU standard G.993.5) is widely deployed from cabinet today and can serve hundreds of users with data rates up to 100 megabits per second (Mbps). ITU standards G993.2 and G993.5 are hereby incorporated by reference as if reproduced in their entirety. Unlike the first versions of DSL technology where fiber terminated at the central office (CO) and digital subscriber line access modules (DSLAMs) were installed at the CO and connected to subscriber copper wires, in VDSL2 deployment fiber is extended up to a cabinet, for example, from fiber to the cabinet (FTTC).

The latest ITU Telecommunication Standardization Sector (ITU-T) copper access DSL technology standard called fast access to subscriber terminals (G.fast) was approved in December of 2014. See, for example, International Telecommunication Union Recommendation G.9701, “Fast Access to Subscriber Terminals (FAST)—Physical layer specification,” 2014, and International Telecommunication Union Recommendation G.9700, “Fast Access to Subscriber Terminals (FAST)—Power spectral density specification, 2014,” which are incorporated herein by reference. The first version of G.fast specifies a power spectrum density (PSD) profile up to 106 megahertz (MHz). The start frequency is programmable but avoids lower than 2 MHz. An amendment 2 of G.fast will be specified in the future that will use more bandwidth (BW). Discrete multi-tone (DMT) is used for modulation that facilitates vectoring and crosstalk cancellation among multiple lines. Table 1 shows an embodiment of the main parameters of G.fast as described in ITU standard G.9701.

TABLE 1
An embodiment of main parameters of G.fast ITU G.9701 standard

| | G.9701- | G.9701 |
|---|---|---|
| | 2014 | Amendment 2 |
| PSD profile BW | 106 MHz | 212 MHz |
| Total transmit | 4 dBm | TBD |
| power | | (7.3 dBm |
| | | assumed here) |
| Number of sub- | 2048 | 4096 |
| carriers | | |
| Sub-carrier spacing | 51.75 | 51.75 kHz |
| | kilohertz | |
| | (kHz) | |
| Symbol rate | 48 kHz | 48 kHz |
| (programmable, | | |
| nominal value | | |
| shown) | | |

G.fast uses time-division duplexing (TDD) to divide the available channel between downstream (DS) and upstream (US) transmission to avoid echo and near-end crosstalk (NEXT). Far-end crosstalk (FEXT) is cancelled using vectoring as described in George Ginis, John Cioffi, “Vectored transmission for digital subscriber line systems,” IEEE JOURNAL ON SELECTED AREAS IN COMMUNICATION, VOL. 20, NO. 5, JUNE 2002, which is incorporated herein by reference. The G.fast modems using 106 MHz of BW can achieve over 1 Gb/s of aggregate (DS+US) user data rate on short loops as discussed in Dong Wei, Amir Fazlollahi, Guozhu Long, and Eric Wang, “G.fast for FTTdp: Enabling gigabit copper access,” Globecom 2014, December 2014, Austin, Tex., WT-1 Workshop paper, which is incorporated herein by reference.

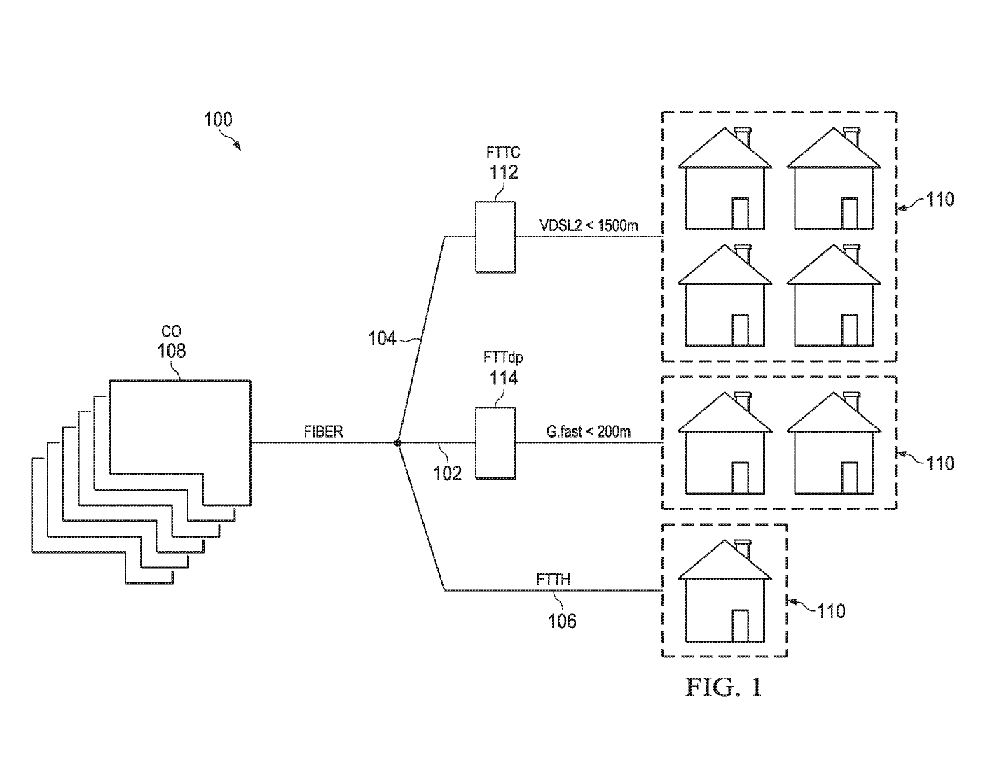

FIG. 1 is a schematic diagram of an embodiment of network 100 comprising FTTdp connections 102, FTTC connections 104, and FTTH connections 106 connecting the central office (CO) 108 with the homes 110. In general, the CO 108 contains optical line terminals (OLTs) to distribute an optical signal over an optical distribution network (ODN), which are conventionally found in or proximate the homes 110. At the end of this network, optical network terminals (ONTs) will convert the optical signal into an electrical signal. The cabinet 112 (e.g., or curb) is a platform that serves several customers (e.g., homes 110). Each of the customers has a connection to the platform via, for example, coaxial cable or twisted pair. FTTdp is similar to FTTC, but moves the end of the fiber to within meters of the boundary of the customers premises (e.g., home). Indeed, the fiber is extended to the last possible junction box, which is known as the “distribution point.” This configuration allows for near-gigabit per second speeds.

Using the FTTdp connections 102, the FTTC connections 104, or the FTTH connections 106, data may be transmitted between the CO 108 and the homes 110. G.fast modems are deployed to utilize the FTTdp connections 102. As shown, when using the FTTdp connections 102 the fiber penetrates very close to the end users in the homes 110. For example, the fiber may be within about 250 m to serve up to a few dozen subscribers. In FIG. 1, the connections from the CO 108 to the cabinet 112, the distribution point 114, and the homes 110 being served by the FTTH connections 106 are fiber, while the other connections from the cabinet 112 and the distribution point 114 to the homes 110 are copper. Reverse powering to power the distribution point 114 at FTTdp, from subscriber homes, is included in G.fast. The amendment 2 of G.fast using 212 MHz will achieve over 2 Gb/s of aggregate data rate while using TDD duplexing and cancelling FEXT from other users.

In G.fast, FEXT cancellation from the neighboring lines is achieved using synchronization and vectoring. FEXT is cancelled in the upstream at the collocated receivers. However, because the subscriber modems are not collocated, the downstream FEXT cannot be cancelled at the receiver. However, a technique called precoding is used to cancel FEXT at the transmitter. The transmitter transmits a signal to the receiver that, by the time it arrives at the receiver, has an opposite phase to the FEXT and therefore cancels it. Using precoding in the downstream and cancellation in the upstream data rates within 95 percent (%) of the FEXT-free communication can be achieved today for G.993.5 modems utilizing 17.6 MHz of BW where FEXT is not very strong compared with the direct channel signal. In G.fast, where FEXT can be very strong at higher frequencies, this number drops to 90% or lower if linear precoding is used. Using non-linear precoding, as described in George Ginis, John Cioffi, “Vectored transmission for digital subscriber line systems,” IEEE JOURNAL ON SELECTED AREAS IN COMMUNICATION, VOL. 20, NO. 5, JUNE 2002, better performance is achievable.

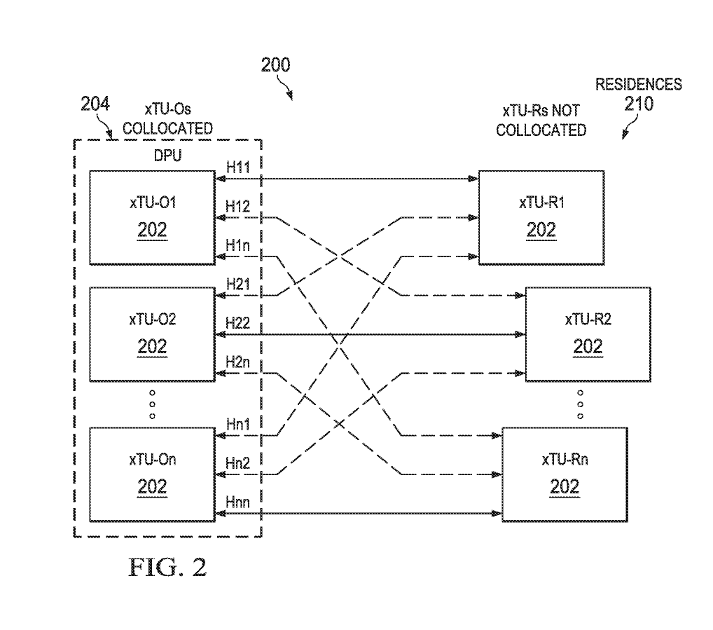

FIG. 2 is a schematic diagram of an embodiment of a vectored DSL network system 200 that may be implemented within the network of FIG. 1. The network system 200 includes several transceiver units 202, some of which are located at the distribution point unit (DPU) 204 and some of which are located at the residences 210. The DPU 204 may be similar to, for example, the cabinet 112 or the distribution point 114 in FIG. 1. The residences 210 may be similar to the homes 110 in FIG. 1. In FIG. 2, xTU means Transceiver Unit where “x” may be “V” for VDSL2 and “F” for G.fast. The “0” stands for office side and the “R” stands for remote subscriber terminal. For a synchronized vectored system consisting of n transceivers at DPU 204 using DMT or orthogonal frequency-division multiplexing (OFDM) modulation, the n received signals Yₙₓ₁ at a given subcarrier are related to n transmitted signals Xₙₓ₁ by the channel matrix Hₙₓₙ. For example, received signals at a given subcarrier may be expressed as:

Yₙₓ₁=HₙₓₙXₙₓ₁+Nₙₓ₁, (1)

where Nₙₓ₁ is the noise vector other than crosstalk. The components of Hₙₓₙ are hᵢⱼ; i, j [symbol] [1, 2, . . . , n] and are fixed or change very slowly (due to temperature or humidity change) over time in a synchronized system. hᵢⱼ is the channel from transmitter j to receiver i. The diagonal components of Hₙₓₙ are the direct channels and the off-diagonal components are FEXT. hᵢⱼ are indicated for upstream transmission in FIG. 2. The channel matrix for the downstream transmission is similarly defined.

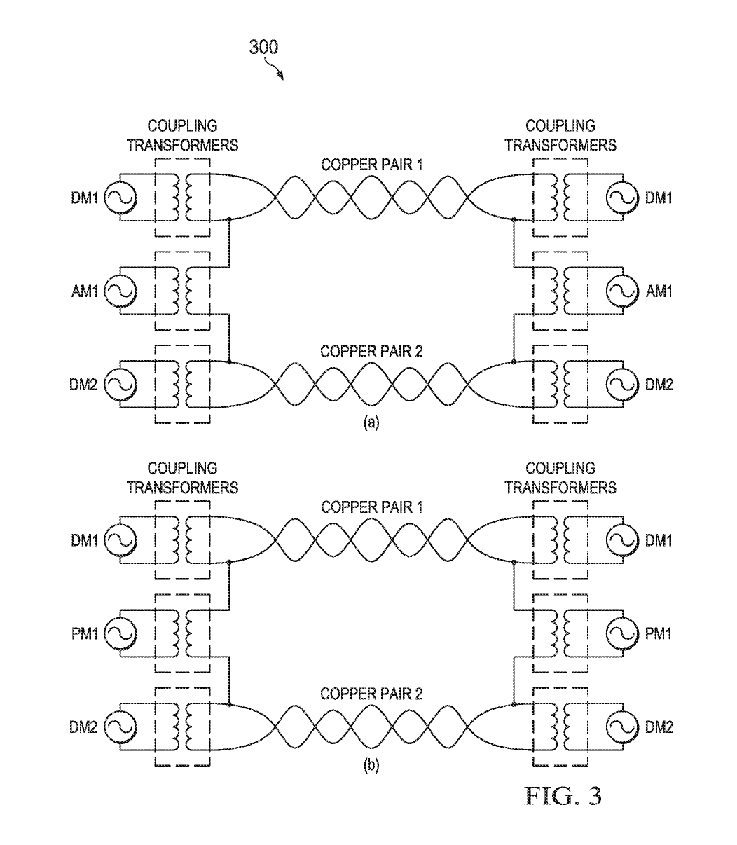

FIG. 3 is a schematic of an embodiment of copper wire pair configurations 300 used to create three channels from two pairs of copper wire (e.g., the copper wire described in connection with FIG. 1). The copper wire in FIG. 3 may be used to facilitate, for example, the FTTC connections 104 or the FTTdp connections 102 in FIG. 1. As noted above, data transmission of over 2 Gb/s is feasible over a single pair of copper using 212 MHz bandwidth. Most residences and businesses in the United States and some other countries are connected by two or more copper pairs to the so-called “service terminal” or “pedestals,” even though only one pair may be active. Using two pairs, three channels are available. In general, with N-pairs, there are 2N wires. Assuming one wire is used as a reference or common ground, there are 2N−1 channels available. As shown in FIG. 3, there are different ways of creating 2N−1 channels from N pairs. For example, 2N−1 channels may be created from N pairs by keeping N differential modes (DM) and creating N−1 alternative modes (AM) as shown in configuration (a) for N=2. The alternative modes are created by connecting the secondary of the coupling transformers to one wire of each copper pair. In another method, N differential modes and N−1 phantom modes (PM) are created. The phantom mode is a differential mode channel created from the common modes of the two copper pairs as shown in configuration (b). In configuration (b), the center-taps of the secondary of the coupling transformers are used to create the phantom mode (PM1). N−1 phantom modes may be created from N pairs, for N>2, similar to the method shown in the figure.

Two or more pairs serving a residence or business with no crosstalk from other users may benefit from MIMO technology because customer side modems are also collocated. Unlike a vectored G.fast system discussed above where coordination is performed from the DPU side only, a MIMO system benefits from coordination at receiver side as well and will not suffer from PSD increase in the transmitter precoder when FEXT is strong as described in George Ginis, John Cioffi, “Vectored transmission for digital subscriber line systems,” IEEE JOURNAL ON SELECTED AREAS IN COMMUNICATION, VOL. 20, NO. 5, JUNE 2002. This is because a MIMO system can use singular value decomposition with pre-coder and post-coder (or post-filter) matrices that are unitary matrices and conserve energy. In addition, such MIMO system gains from channel diversity because in this case FEXT signal from a transmitter to the other receiver is exploited rather than mitigated. Therefore, MIMO is superior to vectoring combined with bonding above the gamma interface (y-interface). Binder MIMO channel models for copper pairs in binder have been studied and derived in Bin Lee, et al, “Binder MIMO channels,” IEEE TRANSACTIONS ON COMMUNICATIONS, VOL 55, NO. 8, August 2007, which is incorporated herein by reference. Gigabit DSL using MIMO DSL channels with phantom mode over 35 MHz was reported in Bin Lee, John Cioffi, Sumanth Jagannathan, Mehdi Mohseni “Gigabit DSL,” IEEE TRANSACTIONS ON COMMUNICATIONS, VOL 55, NO. 9, September 2007, which is incorporated herein by reference. This system achieves peak rate of 1.7 Gb/s over 4 copper pairs using 7 channels (3 phantom modes). In Wim Foubert, et al., “Exploiting the phantom mode signal in DSL applications,” IEEE TRANSACTIONS ON INSTRUMENTATIONS AND MEASUREMENTS, VOL 61, NO. 4, April 2012, which is incorporated herein by reference, the authors reported that phantom mode is an Eigen-mode of the quad cable system and in theory there is no crosstalk between this mode and differential mode. A binder MIMO system is no different from a wireless MIMO system and most mathematics apply similarly, except that the binder MIMO channel, unlike wireless channel, is much more stable and may vary slowly over time due to temperature and humidity changes.

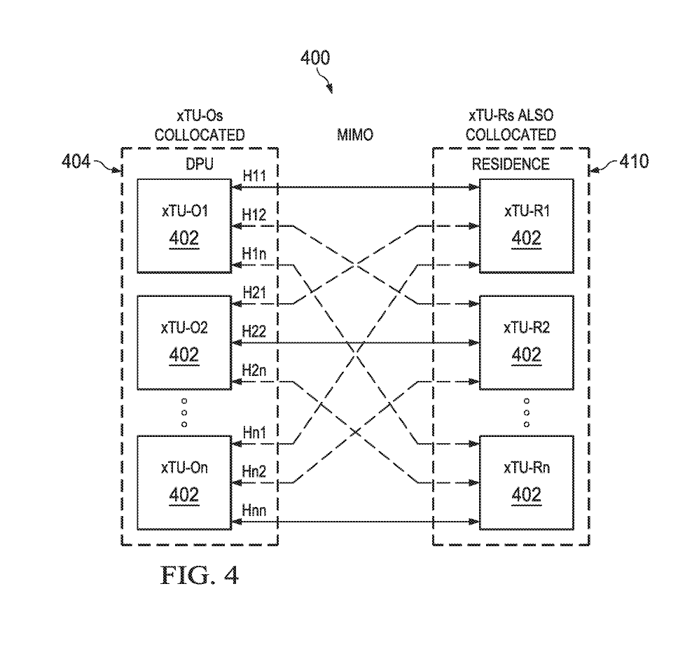

FIG. 4 is a schematic diagram of an embodiment of a MIMO system 400 serving one residence 410 or business subscriber. As shown, the MIMO system 400 includes several transceiver units 402 in a DPU 404 and several transceiver units 402 in a single residence 410. The transceiver units 402 are similar to the transceiver units 202 in FIG. 2. The single residence 410 is similar to the residences 210 in FIG. 2. However, unlike in FIG. 2, the transceiver units 402 in FIG. 4 are all collocated in a single residence 410. In the MIMO system 400 of FIG. 4, both echo (e.g., self-interference) and NEXT can be cancelled if full-duplex signaling (e.g., an overlapped spectrum) is used. Echo and NEXT cancellation in a synchronized MIMO system using DMT modulation has a relatively low complexity as long as length of the cyclic extension is long enough to absorb the echo and NEXT channel impulse responses. In this case, a single-tap complex NEXT and Echo canceller may be used per subcarrier.

Above, the feasibility of over 2 Gb/s data transmission over a single pair of copper using 212 MHz bandwidth was established. Keeping that in mind, a twisted-pair MIMO system using two pairs and full-duplex signaling is able to multiply the channel capacity of the 212 MHz single-pair G.fast by 6 times so that, in theory, the aggregate data rate is increased to over 12 Gb/s. In practice, there may be some implementation loss. By using a bandwidth higher than 212 MHz even higher data rates may be achievable.

A similar technique called XG.fast was reported in Jochen Maes and Carl J. Nuzman, “The past, present, and future of copper access,” Bell Labs Technical Journal, Volume 20, 2015, which is incorporated herein by reference, for hybrid Fiber-Copper access that achieves 10 Gb/s over two pairs of copper. However, that system uses channel duplexing and a BW up to 500 MHz. That system has a more limited reach of 30 m over 0.6 millimeter (mm) copper wires to support 10 Gb/s and is more expensive because it requires wider BW. As will be more fully explained below, the full-duplex echo-cancelled system disclosed herein for the hybrid wireless-wired architecture noted above may use more analog-to-digital converter (ADC) signal-to-noise ratio (SNR) to accommodate for the echo energy, but uses only 212 MHz of BW. Currently, there is no standard defined for either of these two proposed systems to achieve 10 Gb/s over two pairs on telecom-grade copper wire pairs.

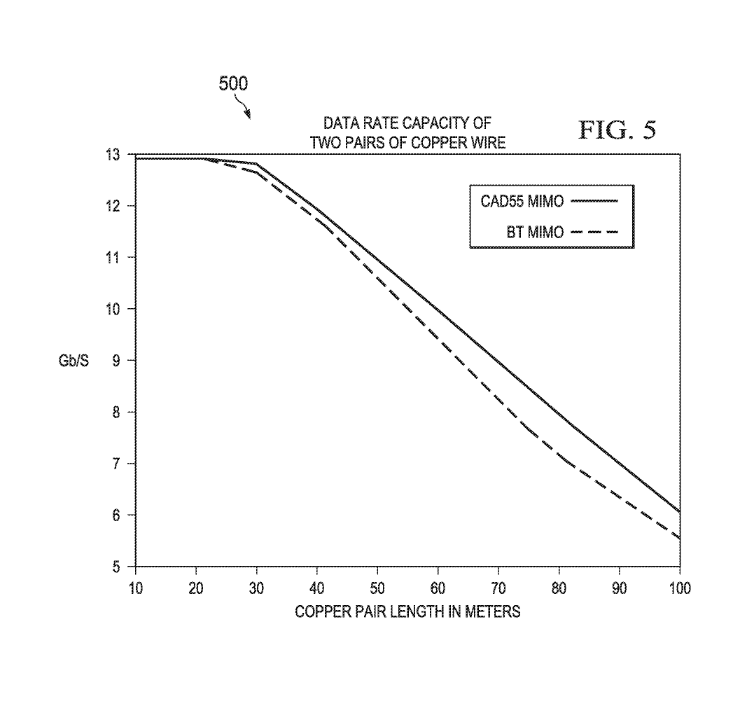

Simulation results are provided to study the channel capacity of two pairs of copper wires when the alternative mode is exploited. FIG. 5 is a graph of an embodiment of simulation results 500 of aggregate data rate versus loop length for two pairs of copper wire serving a residence or business (e.g., the copper wire described in connection with FIG. 1). MIMO processing is used and phantom mode is exploited in the simulations. Two types of copper wires are simulated: CAD55 and BT. CAD55 (B05a) is a 0.5 mm two-pair unshielded aerial copper-wire for which theoretical model is available in G.fast/G.9701 Appendix I. BT is measured data on British Telecom's typical cables (e.g., polyethylene) used in BT's access network as described in BT plc, “G.fast: Release of BT cable (20 pair) measurements for use in simulations,” ITU-T Q4 contribution 2015-02-Q4-053, which is incorporated herein by reference. The measured sampled frequency response data for direct and FEXT channels in the BT plc publication provided over 106 MHz, but has been extended to 212 MHz herein using signal processing techniques and the interp1( . . . , ‘spline’) command in Matlab®, which is the high-level language and interactive environment commercially available from Mathworks of Natick, Mass. Because of inherent filtering involved in interpolation to extend data, the extended sampled frequency responses are more pessimistic (show more loss) than what would the real measurements be. Therefore, the simulation results provided for BT case are pessimistic. Implementation loss as much as 20% at longer loops was also considered in FIG. 5.

Overlapped spectrum full-duplex over 212 MHz with flat PSD of −76 decibel-milliwatts per hertz (dBm/Hz) has been assumed which makes for about 7.3 decibel-milliwatts (dBm) total transmit power. Forward error correction (FEC) with 5 dB net coding gain and 6 dB noise margin were assumed. The additive white Gaussian noise (AWGN) is −140 dBm/Hz and the limited dynamic range of ADCs and digital-to-analog converters (DACs) have been taken into account. The cyclic extension (CE) overhead is about 7%. The maximum number of bits per subcarrier is 12. Amateur (e.g., HAM) radio or frequency modulation (FM) bands are not notched.

The simulation results show that 3-channel MIMO over two pairs using 212 MHz can achieve 10 Gb/s up to 50 m or more. Using wider bandwidth and/or more pairs, even higher data rates at longer loops maybe achievable.

In the paragraphs above, a description of how a copper wire MIMO system is able to evolve from the current 1 Gb/s G.fast standard to deliver more than 10 Gb/s over two or more copper pairs on distances of 50 m or longer to a single subscriber was provided. Below, an explanation is provided as to how such a system may be integrated into a 5G cellular system to connect outdoor and indoor relay stations, or RF repeaters, at the access points. Reverse-powering from subscriber house may be used to power both the outdoor relay station or RF repeater and the outdoor transceiver unit at office side. In an embodiment, the role of the copper is changing from traditional role in Fiber-Copper-WiFi to Cellular-Copper-Cellular or Cellular-Copper-WiFi.

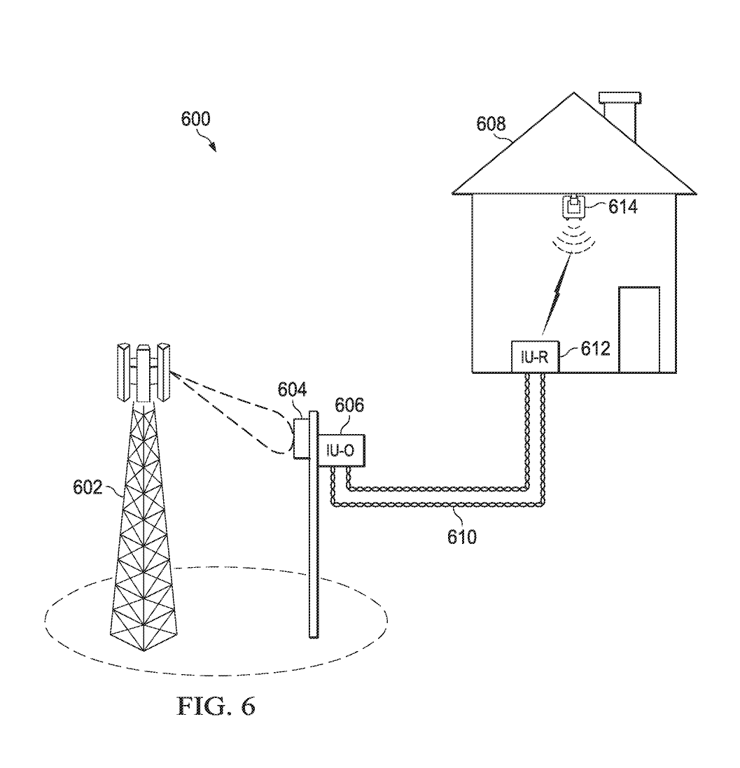

FIG. 6 is a schematic diagram of an embodiment of a cellular copper-assisted wireless system 600 for in-house service and shows a proposed mmWave small cell cellular network connection for an in-house scenario. As will be more fully explained below, the system 600 is an alternative to, for example, the optical transmission options depicted in FIG. 1. As shown in FIG. 6, the system 600 comprises a mmWave small cell base station 602, a mmWave relay station or RF repeater 604 (collectively referred to as a relay station unless otherwise noted), a transceiver (TU-0) 606 outside the residence 608 (or other structure), twisted copper wire pairs 610, a transceiver (TU-R) 612 within the residence 608, and a pico cell base station or RF remote radio unit (RRU) 614 (collectively referred to as an indoor radio station unless otherwise noted).

In an embodiment, the mmWave small cell base station 602 has a specifically formed beam pointing to the targeted residence 608 for coverage. The mmWave small cell base station 602 is in cellular communication with the relay station 604. As shown, the relay station 604 is disposed outside, but proximate or near, the residence 608. By way of example, the relay station 604 could be mounted to the exterior of or atop the residence 608, situated in an equipment cabinet within the yard of the residence 608, or otherwise disposed within about 30 m of the residence 608. The relay station 604 is operably coupled to the transceiver 606. In an embodiment, the relay station 604 and the transceiver 606 are connected by an Ethernet cable, which is capable of sending 10 Gb/s signal. Alternatively, the relay station 604 and the transceiver 606 are designed into a same unit and even a same integrated circuit.

The transceiver 606 is operably coupled to the transceiver 612 via the copper wire pairs 610. In an embodiment, the copper wire pairs 610 are available twisted pairs of copper telephone wires, which are capable of transporting 10 Gb/s traffic load. While two copper wire pairs 610 are shown in FIG. 6, one or several copper wire pairs could be used in the system 600 in other embodiments. The transceiver 612 is operably coupled to the indoor radio station 614. In an embodiment, the indoor radio station 614 and the transceiver 612 are connected by an Ethernet cable or a coaxial (Coax) cable. The indoor radio station 614 and the transceiver 612 may be disposed in separate locations within the residence (e.g., in different rooms, on different floors, etc.). Alternatively, the indoor radio station 614 and the transceiver 612 are designed into a same unit and even the same integrated circuit.

For the downlink (DL) direction, the relay station 604 receives a mmWave signal from the small cell base station 602 and down converts that signal into baseband In-phase (I) and Quadrature (Q) digital signals. The I-Q digital signal is then either pre-processed into other representation of the digital signal or remained in raw I-Q format and framed into data packets and sent into the transceiver 606. The data packets are then transmitted over the copper wire pairs 610 from the transceiver 606 outside the residence 608 to the transceiver 612 inside the residence 608. The transceiver 612 provides the data packets to the indoor radio station 614, which converts those data packets to a radio frequency signal. The indoor radio station 614 then transmits that radio frequency signal to the one or more UEs (not shown) inside the residence. The signals emitted by the indoor radio station 614 provide robust radio frequency (RF) coverage within the house.

On the uplink (UL) side, the indoor radio station 614 receives a radio signal from a UE within the residence 608. The indoor radio station 614 converts the received signal to either digitally framed I-Q data packets or other pre-processed representation of the data and sends those packets to the transceiver 612. The transceiver 612 transmits the data packets to the transceiver 606 over the copper wire pairs 610. The transceiver 606 recovers the data from the either I-Q data packets or other pre-processed representation of data packets and sends the data over the Ethernet cable, or other interface, to the relay station 604. The relay station 604 then converts the received data (in I-Q or other pre-processed representation of the data) to the mmWave signal and transmits the mmWave signal to the small cell base station 602.

The system 600 depicted in FIG. 6 may be configured in a variety of different embodiments. For example, when the indoor radio station 614 is a pico cell base station and not a RRU (which is an option noted above), the links between the digital output of the pico cell base station 614 and the small cell base station 602 are treated as the backhaul of the pico cell base station. The errors that may occur between the pico cell base station and the UE will be processed at the pico cell base station using, for example, error correction such as hybrid automatic repeat request (HARQ).

If, however, the indoor radio station 614 is a RF RRU, then the same errors that occurred at the air interface between the RF RRU and the UE may not be corrected at this interface. Rather, the errors may be propagated back to the link at the small cell base station 602 and processed and corrected there. In this case, the link between the mmWave small cell base station 602, through the transceiver 606 and the transceiver 612 pairs, and before the RF section of the RRU at the other end will all become the front haul to the RRU.

When errors occur between the small cell base station 602 and the relay station 604 near the house, the errors will be processed at the relay station 604 for the DL and at the small cell base station 602 for the UL because both the small cell base station and the relay station have the capability to decode the error and perform re-transmissions. However, when the relay station 604 is a RF repeater, the error correction and retransmission may have to be done at either the small cell base station 602 or the pico cell base station 614, depending on whether the errors occurred at the DL or UL. When indoor radio station 614 is a RRU, then all the errors will be handled at the small cell base station 602, which would create a relatively large delay.

The advantages of passing I-Q digital data from the relay station 604 to the indoor radio station 614, and vice versa, are reduced delay and lower cost. However, the disadvantage of I-Q format is higher data rate requirement as the I-Q samples require more bits than the information they carry. However, data compression techniques may be used to reduce data rate requirements. DMT modulation as previously described, or other types of appropriate modulation may be used to transmit the compressed data through copper wires. Alternatively, the I-Q signal maybe further processed to a different representation of the signal that requires less data rates to transmit. Alternatively, certain level of user data bits may be recovered at mmWave relay station or RF repeater 604 and transmitted through transceiver 606 and copper pairs 610 and the transceiver 612, and vice versa, to reduce data rate at the cost of more delay. The indoor radio station 614 in this case may be a WiFi unit or other technologies unit which uses unlicensed RF spectrum. The added delay of the alternative method is due to the additional demodulation/modulation and FEC decoding/encoding. In this case also, DMT or other types of appropriate modulation may be used to transmit the data through copper wires. If transmitting uncompressed I-Q samples through the copper wires the system may be able to tolerate more errors compared with the case that user bits are transmitted that in return may allow reducing noise margin and increasing capacity further.

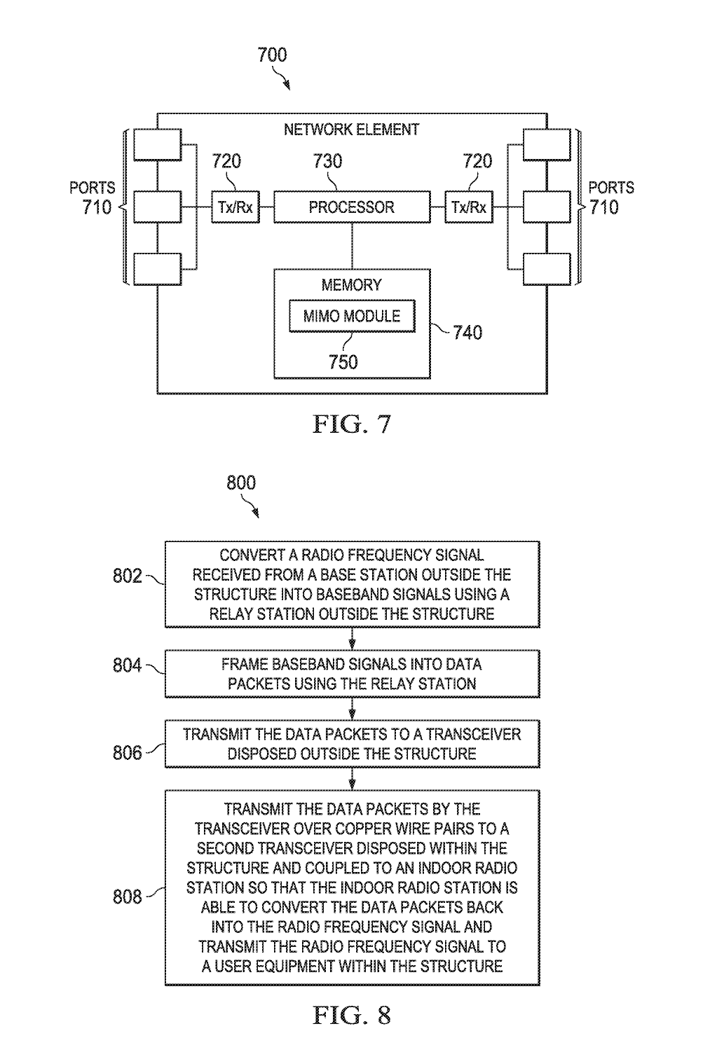

FIG. 7 is a schematic diagram of a network element 700 for implementing copper-assisted wireless system. The network element 700 may be suitable for implementing the disclosed embodiments. For instance, the network element 700 may implement xTUs in a network. The network element 700 may be similar to, for example, the baseband unit of the relay station 604, the transceiver 606, the transceiver 612, and/or the baseband unit of the indoor radio station 614 in FIG. 6. Network element 700 comprises ports 710, transceiver units (Tx/Rx) 720, a processor 730, and a memory 740 comprising a MIMO module 750. Despite the MIMO module 750 being depicted in the memory 740 in FIG. 7, in an embodiment the MIMO module 750 resides within the processor 750. Ports 710 are coupled to Tx/Rx 720, which may be transmitters, receivers, or combinations thereof. The Tx/Rx 720 may transmit and receive data via the ports 710. Processor 730 is configured to process data. Memory 740 is configured to store data and instructions for implementing embodiments described herein.

The processor 730 may be implemented by hardware and software. The processor 730 may be implemented as one or more central processing unit (CPU) chips, logic units, cores (e.g., as a multi-core processor), field-programmable gate arrays (FPGAs), application specific integrated circuits (ASICs), and digital signal processors (DSPs). The processor 730 is in communication with the ports 710, Tx/Rx 720, and memory 740.

The memory 740 comprises one or more of disks, tape drives, and solid-state devices drives and may be used as an over-flow data storage device, to store programs when such programs are selected for execution, and to store instructions and data that are read during program execution. The memory 740 may be volatile and non-volatile and may be read-only memory (ROM), random-access memory (RAM), ternary content-addressable memory (TCAM), and static random-access memory (SRAM). MIMO module 750 is implemented by processor 730 to execute the instructions for implementing various embodiments previously discussed.

FIG. 8 is a flowchart of an embodiment of a method 800 of indoor wireless data access using copper wires. The method may be implemented by, for example, the relay station 604 of FIG. 6. The method 800 may be performed when a radio frequency signal such as a 5G cellular signal from, for example, a small cell base station (e.g., small cell base station 602) is to be delivered to one or more UEs within a structure (e.g., structure 608). In block 802, a radio frequency signal received from a base station outside the structure is converted into baseband signals by a relay station (e.g., relay station 604) outside the structure. In block 804, the baseband signals are framed into data packets by the relay station. In block 806, the data packets are transmitted to a transceiver (e.g., transceiver 606) disposed outside the structure. In block 808, the data packets are transmitted by the transceiver over copper wire pairs (e.g., copper wire pairs 610) to a second transceiver (e.g., transceiver 612) disposed within the structure and coupled to an indoor radio station (e.g., indoor radio station 614) so that the indoor radio station is able to convert the data packets back into the radio frequency signal and transmit the radio frequency signal to a user equipment within the structure.

Various embodiments of the system disclosed herein allow a lower cost and a fast deployment for mmWave 5G wireless cellular systems to residences and businesses. Indeed, the system provides reconfigurable and re-routable multi-hop mmWave backhaul along with unified mmWave backhaul. The system also provides access links that allow massive connectivity and easy deployment for 5G systems. This means future access networks will move away from “fiber backhaul-digital subscriber line (DSL) access to indoor-wireless fidelity (WiFi)” and instead be characterized as “wireless backhaul-a connection to indoor-wireless indoor.” Thus, the traditional role of copper is changing from Fiber-Copper-WiFi to Cellular-Copper-Cellular or to Cellular-Copper-WiFi. The proposed MIMO architecture over multi-pair copper wires will facilitate this migration at a lower cost.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A network element, comprising:
a relay station disposed outside a structure, wherein the relay station is configured to convert a radio frequency signal received from a base station into baseband signals and to frame the baseband signals into data packets; and
a transceiver disposed outside the structure and operably coupled to the relay station, wherein the transceiver is configured to receive the data packets from the relay station and to transmit the data packets over copper wire pairs to a second transceiver disposed within the structure and coupled to an indoor radio station so that the indoor radio station is able to convert the data packets back into the radio frequency signal and transmit the radio frequency signal to a user equipment within the structure.

2. The network element of claim 1, wherein the transceiver and the second transceiver use one or both of an overlapped spectrum full-duplexing technique and multiple-input-multiple-output (MIMO) technique for data transmission.

3. The network element of claim 1, wherein the transceiver is configured to transmit the data packets to the transceiver within the structure over copper wire pairs having N differential modes and 0 to N−1 phantom modes to form up to 2N−1 channels, where N is an integer number from 1 to 8.

4. The network element of claim 1, wherein the relay station comprises a millimeter-Wave (mmWave) relay station.

5. The network element of claim 1, wherein the relay station comprises a radio frequency (RF) repeater.

6. The network element of claim 1, wherein the structure is a residence or a business.

7. The network element of claim 1, wherein either In-phase-Quadrature (I-Q) samples or a representation of down converted radio frequency signal samples is framed into the data packets before being received by the transceiver.

8. The network element of claim 1, wherein I-Q samples or a representation of down converted radio frequency signal samples is compressed and framed into the data packets before being received by the transceiver.

9. The network element of claim 1, wherein information bits of the radio frequency signal are extracted and framed into the data packets before being received by the transceiver.

10. A network element, comprising:
an indoor radio station within a structure configured to convert a radio frequency signal received from a user equipment into baseband signal framed data packets; and
a transceiver within the structure and operably coupled to the indoor radio station, wherein the transceiver is configured to transmit the baseband signal framed data packets over copper wire pairs to a second transceiver outside the structure and coupled to a relay station so that the relay station is able to convert the baseband signal framed data packets back into the radio frequency signal and transmit the radio frequency signal to a small cell base station outside the structure.

11. The network element of claim 10, wherein the transceiver and the second transceiver communicate over the copper wire pairs through one or both of overlapped-spectrum transmissions and multiple-input-multiple-output (MIMO) transmissions.

12. The network element of claim 11, wherein the transceiver is configured to transmit the baseband signal framed data packets to the second transceiver outside the structure over the copper wire pairs having N differential modes and 0 to N−1 phantom modes to form up to 2N−1 channels, where N is an integer number equal to 1 to 8.

13. The network element of claim 10, wherein either In-phase-Quadrature (I-Q) samples or a representation of down converted radio frequency signal samples is framed into the baseband signal framed data packets before being received by the transceiver.

14. The network element of claim 10, wherein I-Q samples or a representation of down converted radio frequency signal samples is compressed and framed into the baseband signal framed data packets before being received by the transceiver.

15. The network element of claim 10, wherein information bits of the radio frequency signal are extracted and framed into the data packets before being received by the transceiver.

16. A method of transmitting wireless signal over copper wires using one or both of overlapped spectrum full-duplexing transmission and multiple-input-multiple-output (MIMO) transmission, comprising:
converting, by a relay station outside a structure, a radio frequency signal received from a base station outside the structure into baseband signals;
framing, by the relay station, the baseband signals into data packets;
transmitting, to a transceiver disposed outside the structure, the data packets; and
transmitting, by the transceiver, the data packets over copper wire pairs to a second transceiver disposed within the structure and coupled to an indoor radio station so that the indoor radio station is able to convert the data packets back into the radio frequency signal and transmit the radio frequency signal to a user equipment within the structure.

17. The method of claim 16, further comprising transmitting the data packets to the second transceiver within the structure over copper wire pairs having N differential modes and 0 to N−1 phantom modes to form up to 2N−1 channels, where N is an integer number equal to 1 to 8.

18. The method of claim 16, wherein either In-phase-Quadrature (I-Q) samples or other representation of down converted radio frequency signal samples is framed into the data packets before being received by the transceiver.

19. The method of claim 16, wherein I-Q samples or other representation of down converted radio frequency signal samples is compressed and framed into the data packets before being received by the transceiver.

20. The method of claim 16, wherein information bits of the radio frequency signal are extracted and framed into the data packets before being received by the transceiver.
